(19) United States
(12) Patent Application Publication
(10) Pub. No.: US 2024/0286217 A1
(43) Pub. Date: Aug. 29, 2024

(54) LASER PROCESSING APPARATUS INCLUDING BEAM ANALYSIS SYSTEM AND METHODS OF MEASUREMENT AND CONTROL OF BEAM CHARACTERISTICS

(71) Applicant: ELECTRO SCIENTIFIC INDUSTRIES, INC., Beaverton, OR (US)

(72) Inventors: Joe HASTY, Portland, OR (US); Jay DAVIS, Portland, OR (US)

(73) Assignee: ELECTRO SCIENTIFIC INDUSTRIES, INC., Beaverton, OR (US)

(21) Appl. No.: 18/570,791

(22) PCT Filed: Jun. 14, 2022
(86) PCT No.: PCT/US2022/033390

§ 371 Date: Dec. 15, 2023

Related U.S. Application Data
(60) Provisional application No. 63/213,075, filed on Jun. 21, 2021.

(51) Int. Cl. B23K 26/06; B23K 26/70; G01J 1/42; G02F 1/29; G02F 1/33

(52) U.S. Cl. CPC B23K 26/06; B23K 26/705; G01J 1/42; G02F 1/292; G02F 1/33; G01J 2001/4247; G02F 2203/24

(57) ABSTRACT

Numerous embodiments of a laser-processing apparatus are disclosed. In one embodiment, the laser-processing apparatus includes a laser source operative to generate a beam of laser energy, an acousto-optic deflector (AOD) arranged within a beam path, a controller coupled to the AOD, and a beam analysis system operative to measure characteristics of the beam, generate measurement data representative of the measured beam characteristics, and transmit the measurement data to a controller operative to control the operation of the AOD based on that measurement data. In another embodiment, the laser-processing apparatus includes a system for characterization of cross-axis wobble of a galvanometer mirror, comprising a reference laser source configured to emit a reference laser beam, a reflective surface formed on the galvanometer mirror and configured to reflect the reference laser beam to a sensor configured to output a signal representative of the position of the reference beam to a controller.

### CROSS-REFERENCE TO RELATED APPLICATIONS

This application claims the benefit of U.S. Provisional Application No. 63/213,075, filed Jun. 21, 2021, the contents of which are incorporated by reference in their entirety.

### TECHNICAL FIELD

Embodiments described herein relate generally to laser-processing apparatuses and, more particularly, to acousto-optic deflectors (AODs), the components thereof, and techniques for operating the same, in order to process a workpiece.

### BACKGROUND

Laser-processing systems or apparatus are used in a wide variety of applications, including printed circuit board (PCB) machining, additive manufacturing, and the like. To process PCBs, precise control of ablation of the PCB materials (e.g., metals, insulators, used in forming vias, etc.) is required when, for example, laser-processing is used to form holes or vias therein. In some applications, control of the operation of the AODs used to diffract the laser-processing beam while processing the workpiece can be challenging. Specifically, changes to the laser spot size by chirping the AODs may be difficult to control, and characterization of the processing beam can be time-consuming and may not provide the precise control required. Ensuring proper/correct AOD chirp requires precise timing of the laser pulse and the acoustic wavefront as it passes through the AOD. Incorrect timing between control commands for the AOD and the laser source can result in poor spot position displacement and poor spot quality, reducing overall system accuracy and feature quality. Closed-loop control of this timing can improve overall system performance, including throughput and yield. The embodiments discussed herein were developed in recognition of these and other problems discovered by the inventors.

### SUMMARY

One embodiment of the present disclosure can be characterized as a laser processing apparatus that includes: a laser source operative to generate a beam of laser energy propagatable along a beam path, an acousto-optic deflector (AOD) arranged within the beam path and is operative to diffract the beam of laser energy, a controller coupled to the AOD, and a beam analysis system operative to measure one or more characteristics of the beam of laser energy, generate measurement data representative of one or more of the measured beam characteristics, and transmit the measurement data to the controller, wherein the controller is operative to control an operation of the AOD based, at least in part, on the measurement data.

Another embodiment of the present disclosure is a method of controlling laser beam characteristics, comprising: generating a beam of laser energy, directing (using an AOD) the beam of laser energy along a beam path to a beam analysis system, measuring (using the beam analysis system) one or more characteristics of the beam of laser energy, generating measurement data representative of one or more of the measured beam characteristics, transmitting the measurement data from the beam analysis system to a controller, and outputting control commands from the controller to the AOD based, at least in part, on the measurement data.

In another embodiment, a method of controlling laser beam characteristics comprises: generating a beam of laser energy, directing, using at least one selected from the group consisting of a first AOD and a second AOD, the beam of laser energy along a beam path to a beam analysis system, measuring (using the beam analysis system) one or more characteristics of the beam of laser energy, generating measurement data representative of one or more of the measured beam characteristics, transmitting the measurement data from the beam analysis system to a controller, and outputting control commands from the controller to at least one of the first AOD and the second AOD based, at least in part, on the measurement data.

In another embodiment, a method of controlling laser beam characteristics comprises: generating a beam of laser energy, directing (using an AOD), the beam of laser energy along a beam path to a beam analysis system, wherein the AOD is operative to change a first characteristic of the beam of laser energy, thereby changing a second characteristic of the beam of laser energy, then measuring, using the beam analysis system, the second beam characteristic, then generating measurement data representative of the measured second beam characteristic, and transmitting the measurement data from the beam analysis system to a controller, followed by outputting control commands from the controller to the AOD based, at least in part, on the measurement data, wherein the AOD is operative reduce the magnitude of the change in the second beam characteristic.

Another embodiment of the present disclosure is a method comprising: during a measurement step: generating a plurality of laser pulses based on a control command sent to a laser source from a controller, generating an acoustic signal within an AOD based on an AOD control command sent to the AOD from the controller, wherein the acoustic signal is configured to diffract at least one laser pulse of the plurality of laser pulses, measuring at least one characteristic of the plurality of diffracted laser pulses, wherein, during the measuring, adjusting a timing offset between the control command and the AOD control command, generating measurement data representative of the at least one measured characteristic for each diffracted laser pulse, and correlating at least one measurement datum of the measurement data with the timing offset associated with each diffracted laser pulse, followed by, during a workpiece-processing step: generating a laser pulse, generating an acoustic signal within an AOD, wherein the acoustic signal is configured to diffract at least one laser pulse of the plurality of laser pulses, directing the at least one diffracted laser pulse to a workpiece, wherein the timing offset between the laser control command and the AOD control command corresponds to a timing offset that was correlated with the measurement data in the measurement step that has a predetermined relationship with a reference characteristic.

Another embodiment of the present disclosure is a method comprising: during a measurement step: generating a beam of laser energy, generating an acoustic signal within an AOD, wherein the acoustic signal is configured to diffract the beam of laser energy, measuring at least one characteristic of the diffracted beam of laser energy, generating measurement data representative of the at least one measured characteristic for the diffracted beam of laser energy, and correlating at least one measurement datum of the measurement data with a reference value of one or more system operating parameters associated with the diffracted beam of laser energy, followed by, during a workpiece-processing step: generating an acoustic signal within the AOD, wherein the acoustic signal is configured to diffract the beam of laser energy, and directing the beam of laser energy to a workpiece, wherein the characteristic of the beam of laser energy corresponds to a reference value of the at least one of the system operating parameters that was correlated with the measurement data in the measurement step that has a predetermined relationship with the characteristic of the beam of laser energy.

Another embodiment of the present disclosure is a method for correcting for laser beam astigmatism, comprising: generating a beam of laser energy, directing, using a first AOD, the beam of laser energy along a beam path to a beam analysis system, measuring, using the beam analysis system, a beam astigmatism of the beam of laser energy, generating, using the beam analysis system, measurement data representative of the measured beam astigmatism of the beam of laser energy, transmitting the measurement data to a controller, outputting control commands from the controller to a second AOD, wherein the control commands operative to operate the second AOD to correct for the measured beam astigmatism.

Another embodiment of the present disclosure is a system for characterization of cross-axis wobble of an galvanometer mirror, comprising: a reference laser source configured to emit a reference laser beam, a reflective surface formed on the galvanometer mirror and configured to reflect the reference laser beam as a reflected beam, and an auxiliary sensor configured to receive the reflected beam at a reference spot and output a signal representative of the position of the reference spot to a controller.

Another embodiment of the present disclosure is a method for correcting for cross-axis wobble of an galvanometer mirror, comprising: emitting a reference laser beam from a reference laser source, the reference laser beam being incident on a reflective surface formed on the galvanometer mirror; sensing a reflected laser beam using an auxiliary sensor configured to receive the reflected laser beam at a reference spot, output a signal representative of the position of the reference spot to a controller, wherein the controller receives the signal representative of the position of the reference spot, calculating a compensation for the cross-axis wobble, and outputting commands to an AOD system to operate the AOD system to correct for the cross-axis wobble.

Another embodiment of the present disclosure is a beam analysis system, comprising: a token having a reflective surface formed thereon, wherein the reflective surface is configured to reflect at least a portion of an incident first-order beam of propagating along a beam path, a plurality of apertures formed in the reflective surface, wherein the token is formed of a material that is more transmissive to a beam of laser energy than the reflective surface, and a photodetector assembly arranged optically downstream of the token.

Another embodiment of the present disclosure is a laser-processing apparatus, comprising: a laser source operative to generate a beam of laser energy, wherein the beam of laser energy is propagatable along a beam path, an acousto-optic deflector (AOD) arranged within the beam path, wherein the AOD is operative to deflect the beam path along a first direction, a galvanometer mirror operative to deflect the beam path along a second direction different from the first direction, and a controller coupled to the AOD and the galvanometer mirror, the controller operative to control an operation of the galvanometer mirror to induce cross-axis wobble in the galvanometer mirror and to control an operation of the AOD to correct for the cross-axis wobble.

### BRIEF DESCRIPTION OF THE DRAWINGS

FIG. 1 schematically illustrates a laser-processing apparatus, according to one embodiment.

FIG. 2 schematically illustrates an acousto-optic deflector control diagram, according to one embodiment.

FIGS. 3 and 4 schematically illustrates an exemplary characterization of a beam of laser energy using a beam analysis system, according to one embodiment.

FIG. 5 schematically illustrates an exemplary beam characterization tool, according to one embodiment.

FIG. 6 shows a plan view of a token used with the embodiment of the beam characterization tool shown in FIG. 5.

FIG. 7 schematically illustrates an exemplary apparatus for measuring vibrational modes of a galvanometer shaft according to one embodiment.

FIG. 8 shows a view of a photodiode configured to measure a reflected beam of laser energy, according to one embodiment.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below”, or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. SYSTEM OVERVIEW

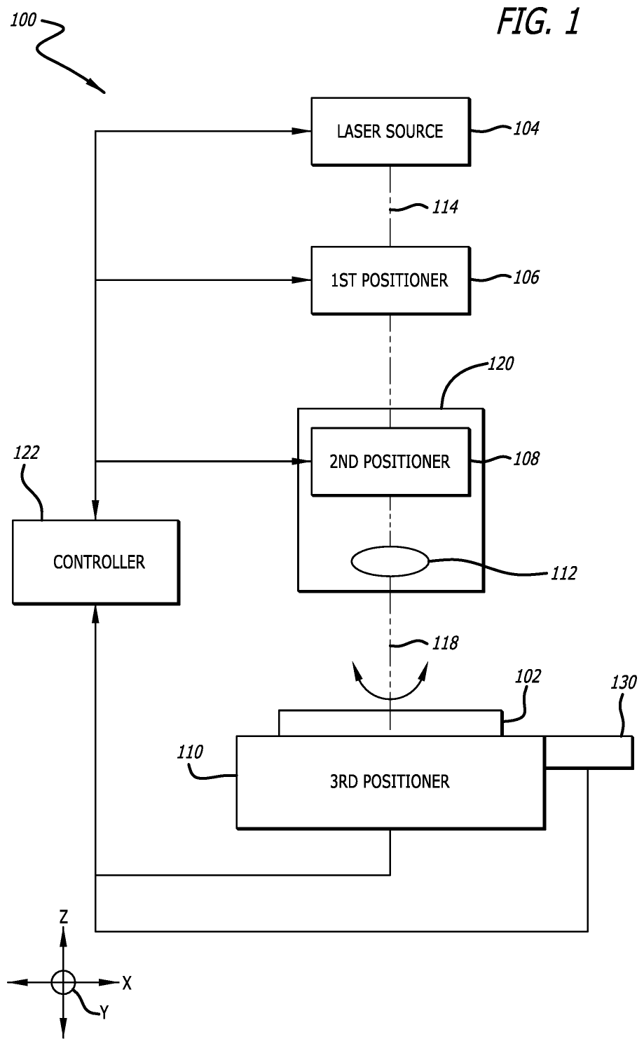

FIG. 1 schematically illustrates a laser-processing apparatus in accordance with one embodiment of the present invention.

Referring to the embodiment shown in FIG. 1, a laser-processing apparatus 100 (also referred to herein simply as an “apparatus”) for processing a workpiece 102 can be characterized as including a laser source 104 for generating a beam of laser energy, one or more positioners (e.g., a first positioner 106, a second positioner 108, a third positioner 110, or any combination thereof) and a scan lens 112. The scan lens 112 and the second positioner 108 may be integrated into a scan head 120, described in further detail below.

Laser energy transmitted along a beam path 114, through the scan lens 112, propagates along a beam axis 118 so as to be delivered to the workpiece 102. Laser energy propagating along the beam axis 118 may be characterized as having a Gaussian-type spatial intensity profile or a non-Gaussian-type (i.e., “shaped”) spatial intensity profile (e.g., a “top-hat” spatial intensity profile). Regardless of the type of spatial intensity profile, the spatial intensity profile can also be characterized as a shape (i.e., a cross-sectional shape, also referred to herein as a “spot shape”) of the beam of laser energy propagating along the beam axis 118 (or beam path 114), which may be circular, elliptical, square, rectangular, triangular, hexagonal, ring-shaped, etc., or arbitrarily shaped. As used herein, the term “spot size” refers to the diameter or maximum spatial width of the beam of laser energy delivered at a location (also referred to as a “process spot,” “spot location” or, more simply, a “spot”) where the beam axis 118 intersects a region of the workpiece 102 that is to be, at least partially, processed by the delivered beam of laser energy. For purposes of discussion herein, spot size is measured as a radial or transverse distance from the beam axis 118 to where the optical intensity drops to, at least, 1/e² of the optical intensity at the beam axis 118. Generally, the spot size of the beam of laser energy will be at a minimum at the beam waist.

Generally, the aforementioned positioners (e.g., the first positioner 106, the second positioner 108 and the third positioner 110) are configured to change the relative position between the spot and the workpiece 102. In view of the description that follows, it should be recognized that inclusion of the second positioner 108 is optional, provided that the apparatus 100 includes the first positioner 106 and, optionally, the third positioner 110. Likewise, it should be recognized that inclusion of the third positioner 110 is optional, provided that the apparatus 100 includes the first positioner 106 and, optionally, the second positioner 108.

### A. Laser Source

In one embodiment, the laser source 104 is operative to generate laser pulses. As such, the laser source 104 may include a pulsed laser source, a CW laser source, a QCW laser source, a burst mode laser, or the like or any combination thereof. In the event that the laser source 104 includes a QCW or CW laser source, the laser source 104 may be operated in a pulsed mode, or may be operated in a non-pulsed mode but further include a pulse gating unit (e.g., an acousto-optic (AO) modulator (AOM), a beam chopper, etc.) to temporally modulate the laser radiation output from the QCW or CW laser source. The laser source 104 may be operated a “burst-mode” where multiple individual pulses may be grouped within a burst envelope. Within the burst envelope, power of each pulse and the time between each pulse may be tailored to specific laser-processing requirements. Thus, the laser source 104 can be broadly characterized as operative to generate a beam of laser energy, which may be manifested as a series of laser pulses or as a continuous or quasi-continuous laser beam, which can thereafter be propagated along the beam path 114. Although some embodiments discussed herein refer to laser pulses, it should be recognized that continuous or quasi-continuous beams may alternatively, or additionally, be employed whenever appropriate or desired.

In addition to wavelength, average power and, when the beam of laser energy is manifested as a series of laser pulses, pulse duration and pulse repetition rate, the beam of laser energy delivered to the workpiece 102 can be characterized by one or more other characteristics such as pulse energy, peak power, etc., which can be selected (e.g., optionally based on one or more other characteristics such as wavelength, pulse duration, average power and pulse repetition rate, etc.) to irradiate the workpiece 102 at the process spot at an optical intensity (measured in W/cm²), fluence (measured in J/cm²), etc., sufficient to process the workpiece 102 (e.g., to form one or more features).

### B. First Positioner

The first positioner 106 is arranged, located or otherwise disposed in the beam path 114 and is operated to diffract, reflect, refract, or the like, or any combination thereof, laser pulses that are generated by the laser source 104 so as to deflect or impart movement of the beam path 114 (e.g., relative to the scan lens 112) and, consequently, deflect or impart movement of the beam axis 118 relative to the workpiece 102. Generally, the first positioner 106 is operated to impart movement of the beam axis 118 relative to the workpiece 102 along the X-axis (or direction), the Y-axis (or direction), or a combination thereof. Although not illustrated, the X-axis (or X-direction) will be understood to refer to an axis (or direction) that is orthogonal to the illustrated Y- and Z-axes (or directions).

In embodiments disclosed herein, the first positioner 106 is provided as one or more AO deflector (AOD) systems, operative to deflect the beam path 114 by diffracting an incident laser beam. Diffracting an incident laser beam produces a diffraction pattern that typically includes zeroth- and first-order diffraction peaks, and may also include higher-order diffraction peaks (e.g., second-order, third-order, etc.). Within the art, it is common to refer to the portion of the diffracted laser beam in the zeroth-order diffraction peak as a “zeroth-order” beam, to refer to the portion of the diffracted laser beam in the first-order diffraction peak as a “first-order” beam, and so on. Generally, the zeroth-order beam and other diffracted-order beams (e.g., the first-order beam, etc.) propagate along different beam paths upon exiting the AOD system. Laser energy in the zeroth-order beam (and any other high-order beams other than the first-order beam) can be absorbed at one or more beam dumps (not shown) in any suitable or desired manner, while laser energy in the first-order beam is allowed to propagate along the beam path 114. AODs of AOD systems generally include an AOD crystal formed of a material such as crystalline germanium (Ge), gallium arsenide (GaAs), wulfenite (PbMoO₄), tellurium dioxide (TeO₂), crystalline quartz, glassy SiO₂, arsenic trisulfide (As₂S₃), lithium niobate (LiNbO₃), or the like or any combination thereof.

### C. Second Positioner

The second positioner 108 is disposed in the beam path 114 and is operated to diffract, reflect, refract, or the like or any combination thereof, laser pulses that are generated by the laser source 104 and passed by the first positioner 106 so as to deflect or impart movement to the beam path 114 (e.g., relative to the scan lens 112) and, consequently, deflect or impart movement of the beam axis 118 relative to the workpiece 102. Generally, the second positioner 108 is operated to impart movement of the beam axis 118 relative to the workpiece 102 along the X-axis (or direction), the Y-axis (or direction), or a combination thereof. In view of the above, it should be appreciated that the second positioner 108 can be provided as an AOD system, a galvanometer mirror scanning system, a rotating polygon mirror system, a deformable mirror, a micro electro-mechanical system (MEMS) reflector, or the like or any combination thereof.

### D. Third Positioner

In the illustrated embodiment, the third positioner 110 includes one or more linear stages (e.g., each capable of imparting translational movement to the workpiece 102 along the X-, Y- and/or Z-directions), one or more rotational stages (e.g., each capable of imparting rotational movement to the workpiece 102 about an axis parallel to the X-, Y- and/or Z-directions), or the like or any combination thereof arranged and configured to impart relative movement between the workpiece 102 and the scan lens 112, and, consequently, to impart relative movement between the workpiece 102 and the beam axis 118. According to embodiments described herein, and although not illustrated, the third positioner 110 includes one or more stages configured and adapted to impart relative movement between the scan lens 112 and the first positioner 106.

In view of the configurations described herein, it should be recognized that movement of the process spot relative to the workpiece 102 (e.g., as imparted by the first positioner 106 and/or the second positioner 108) can be superimposed by any movement of the workpiece 102 or scan lens 112 as imparted by the third positioner 110.

In the illustrated embodiment, the third positioner 110 is operated to move the workpiece 102. In another embodiment, however, the third positioner 110 is arranged and operative to move the scan head 120 and, optionally, one or more components such as the first positioner 106 and the workpiece 102 may be kept stationary.

In one embodiment in which the third positioner 110 includes a Z-stage, the Z-stage may be arranged and configured to move the workpiece 102 along the Z-direction; in this case, the Z-stage may be carried by one or more of the other aforementioned stages for moving or positioning the workpiece 102, may carry one or more of the other aforementioned stages for moving or positioning the workpiece 102, or any combination thereof. In another embodiment in which the third positioner 110 includes a Z-stage, the Z-stage may be arranged and configured to move the scan head along the Z-direction. Moving the workpiece 102 or the scan head along the Z-direction can result in a change in spot size at the workpiece 102.

### E. Scan Lens

The scan lens 112 (e.g., provided as either a simple lens, or a compound lens) is generally configured to focus the beam of laser energy directed along the beam path, typically so as to produce a beam waist that can be positioned at or near the desired process spot. The scan lens 112 may be provided as a non-telecentric f-theta lens (as shown), a telecentric f-theta lens, an axicon lens (in which case, a series of beam waists are produced, yielding a plurality of process spots displaced from one another along the beam axis 118), or the like or any combination thereof.

In one embodiment, the scan lens 112 is provided as a fixed-focal length lens and is coupled to a scan lens positioner (e.g., a lens actuator, not shown) operative to move the scan lens 112 (e.g., so as to change the position of the beam waist along the beam axis 118). For example, the lens actuator may be provided as a voice coil operative to linearly translate the scan lens 112 along the Z-direction. In this case, the lens actuator can be considered here as a component of the aforementioned third positioner 110. Changing the position of the beam waist along the beam axis 118 can result in a change in spot size at the workpiece 102.

As described above, in one embodiment, the scan lens 112 and the second positioner 108 are integrated into a common scan head 120. Thus, in an embodiment in which the apparatus 100 includes a lens actuator, the lens actuator may be coupled to the scan lens 112 (e.g., so as to enable movement of the scan lens 112 within the scan head 120, relative to the second positioner 108). Alternatively, the lens actuator may be coupled to the scan head 120 and be operative to enable movement of the scan head itself, in which case the scan lens 112 and the second positioner 108 would move together). In either case, the lens actuator can be considered here as a component of the aforementioned third positioner 110. In another embodiment, the scan lens 112 and the second positioner 108 are integrated into different housings (e.g., such that the housing in which the scan lens 112 is integrated is movable relative to the housing in which the second positioner 108 is integrated).

### F. Controller

Generally, the apparatus 100 includes one or more controllers, such as controller 122, to control, or facilitate control of, the operation of the apparatus 100. In one embodiment, the controller 122 is communicatively coupled (e.g., over one or more wired or wireless communications links) to one or more components of the apparatus 100, such as the laser source 104, the first positioner 106, the second positioner 108, third positioner 110, the lens actuator, the scan lens 112 (when provided as a variable-focal length lens), the fixture, etc., which are thus operative in response to one or more control signals output by the controller 122.

For example, the controller 122 may control an operation of the first positioner 106, the second positioner 108, or the third positioner 110, or any combination thereof, to impart relative movement between the beam axis 118 and the workpiece 102 so as to cause relative movement between the process spot and the workpiece 102 along a path or trajectory (also referred to herein as a “process trajectory”) within the workpiece 102. It will be appreciated that any two of these positioners, or all three of these positioners, may be controlled such that two positioners (e.g., the first positioner 106 and the second positioner 108, the first positioner 106 and the third positioner 110, or the second positioner 108 and the third positioner 110), or all three positioners simultaneously impart relative movement between the process spot and the workpiece 102 (thereby imparting a “compound relative movement” between the beam axis and the workpiece).

### G. Beam Analysis System

The apparatus 100 may include a beam analysis system 130 operative to measure one or more characteristics of the beam of laser energy. A variety of beam characteristics can be measured using the beam analysis system 130, including beam diameter, spot size, spot position, beam circularity, beam astigmatism, focus height, beam waist size, beam waist position (e.g., along the X, Y, or Z directions), beam axis position, spatial energy distribution, pulse repetition rate, average power, peak power, or the like or any combination thereof. Measurements of the beam characteristics listed above can be used by the controller 122 to calculate laser beam parameters such as beam astigmatism and focus height (e.g., height of the beam waist relative to a known datum). The beam analysis system 130 can generate measurement data representative of these measured beam characteristics and transmit the measurement data (e.g., as one or more measurement signals) to the controller 122. In some embodiments, the measurement data transmitted to the controller 122 are representative of the timing of a pulse or number of pulses emitted by the laser source 104. The controller 122 may then interpret, apply or otherwise process the measurement data to control the operation of one or more positioners (e.g., the first positioner 106, the second positioner 108, the third positioner 110 or any combination thereof).

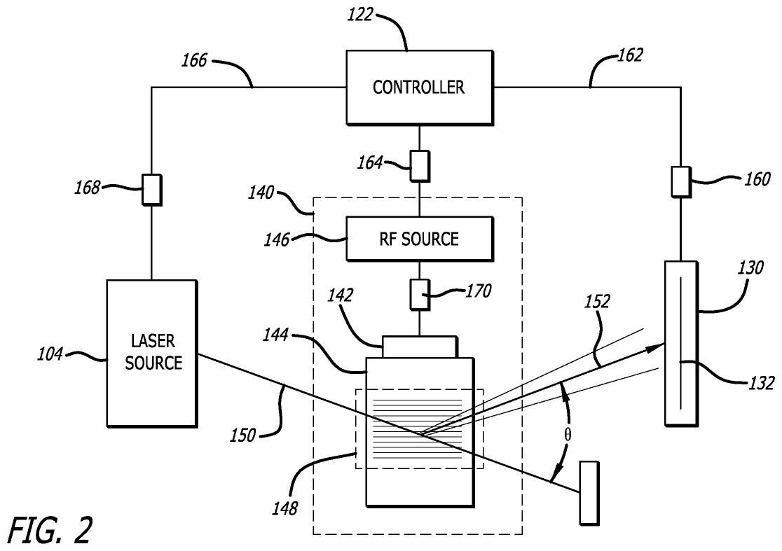

The beam analysis system 130 can be mounted to the third positioner 110 (as shown in FIG. 1), or to any of a variety of other structures or stages as required or beneficial. For example, the third positioner 110 can include one or more linear stages (e.g., as described above) and the beam analysis system 130 can be mounted to the same linear stage (e.g., at a side surface thereof) or to any fixture coupled to the third positioner 110. In one embodiment, the beam analysis system 130 is provided as a camera-based beam profiler configured to measure light that is Rayleigh-scattered from the beam of laser energy onto a photodetector. In another embodiment, the beam analysis system 130 is provided as a knife-edge feature that is mounted optically upstream from a photodetector so that the amount of optical power that passes the knife-edge and is incident on the photodetector can be measured and correlated to a known position of the knife-edge in one or more axes or directions. In another embodiment, the beam analysis system 130 is provided as a camera-based beam profiler configured to focus the beam onto a photodetector positioned directly along the beam axis 118, either directly, or through an attenuating filter. In another embodiment, the beam analysis system 130 is provided as a rotating-slit beam profiler. In each of these configurations of the beam analysis system 130, the beam is measured at the plane of the photodetector (i.e., the detector plane 132, as shown in FIG. 2).

### II. CHIRPING AODS, GENERALLY

Generally, the controller 122 may control the operation of one or more AODs of the first positioner 106 to change the shape of a spot (i.e., “spot shape”) illuminated on the workpiece 102 by laser energy propagating along beam axis 118, to change the size of the spot (i.e., “spot size”), or the like, by applying a chirped RF signal to one or more ultrasonic transducer elements of the AODs. When applied to an AOD, a chirped RF signal has the effect of creating a chirped acoustic waveform (i.e., an acoustic waveform having an instantaneous frequency that varies over time, also referred to as “chirped acoustic signal”) propagating through the AOD crystal. In contrast, a “non-chirped” acoustic waveform, or a “non-chirped acoustic signal,” refers to an acoustic waveform having a substantially invariant instantaneous frequency. A first-order beam diffracted by a chirped acoustic signal may be referred to as a “chirped beam,” a “chirped first-order beam,” or the like. The rate with which the frequency of the RF signal changes is referred to as the “chirp rate” (e.g., measured in MHz/μs). The applied RF signal may be chirped linearly, or non-linearly, or in any other desired or suitable manner. Within an AOD crystal, the variation in instantaneous frequency of the chirped acoustic waveform has the effect of applying a single-axis (astigmatic) focusing term (or cylindrical-lensing effect) to the first-order beam, changing the collimation (i.e., to diverge or converge, depending on the sign of the chirp rate, relative to an incident beam) of the first-order beam exiting the AOD.

### III. EMBODIMENTS CONCERNING THE LASER-PROCESSING APPARATUS WITH THE BEAM ANALYSIS SYSTEM

As described above, the beam analysis system 130 may be incorporated into the laser-processing apparatus 100 to enable measurement of a variety of beam characteristics. Measurement data generated by the beam analysis system 130 can be provided as feedback to the system controller 122. The controller 122 can process the feedback to modify the control commands sent to one or more AODs of the first positioner 106 and/or the laser source 104. For example, when an AOD (e.g., a first AOD) is driven to produce a chirped first-order beam, thereby changing one beam characteristic of the incident beam (e.g., increasing the spot size of the first-order beam relative to the incident beam), other beam characteristics of the incident beam (e.g., spot positioning, beam astigmatism, etc.) may undesirably change as a result. The beam analysis system 130 is used to measure one or more of these beam characteristics and provide measurement data to the controller 122 so that the controller 122 can drive the first AOD or a second AOD to correct, compensate for, or otherwise minimize such changes to beam characteristics. In addition, the measurement data sent to the controller 122 from the beam analysis system 130 may be used to optimize or tailor particular beam characteristics of the first-order beam to enable a variety of workpiece-processing functions. What follows below is a discussion of exemplary embodiments of systems and methods for using the beam analysis system 130 to execute this closed-loop of the first positioner 106.

### A. Embodiments of a Beam Analysis System Configured for AOD System Control

FIG. 2 illustrates a control schematic showing an embodiment of the functional relationship between the controller 122, the laser source 104, an AOD system 140 of the first positioner 106, and the beam analysis system 130 described above with respect to FIG. 1. In this embodiment, the AOD system 140 includes an ultrasonic transducer 142, an AOD crystal 144 and an RF source 146.

The RF source 146 is configured to create and transmit an RF signal 170 (e.g., in response to one or more control commands 164 output from the controller 122). The RF signal 170 is transmitted to the ultrasonic transducer 142, which is configured to generate one or more acoustic waves or waveforms 148 (i.e., an acoustic signal 148) propagatable through the AOD crystal 144 in response to the applied RF signal 170. The acoustic signal 148 diffracts an incident beam 150 (e.g., output from the laser source 104 in response to control or triggering commands 168 output from the controller 122 via a communication link 166) so as to produce a first-order beam 152 that is diffracted to the detector plane 132 of the beam analysis system 130 (e.g., by angle θ). The beam analysis system 130 is operated to measure at least one beam characteristic of the first-order beam 152, and generate and transmit corresponding measurement data 160 to the controller 122 via a communication link 162. The controller 122 may then control the operation of one or more positioners (e.g., the first positioner 106, the second positioner 108, and the third positioner 110 (shown in FIG. 1) or any combination thereof) based, at least in part, on this measurement data.

In the illustrated embodiment, the first positioner 106 includes only one AOD system 140 capable of inducing an astigmatism or cylindrical-lensing effect along a single axis to produce a chirped first-order beam 152. In another embodiment, however, the first positioner 106 includes multiple AOD systems 140 arranged to diffract the incident beam 150 along different (e.g., mutually orthogonal) axes, and would thus be capable of inducing an astigmatism or cylindrical-lensing effect along multiple axes to produce the chirped first-order beam 152.

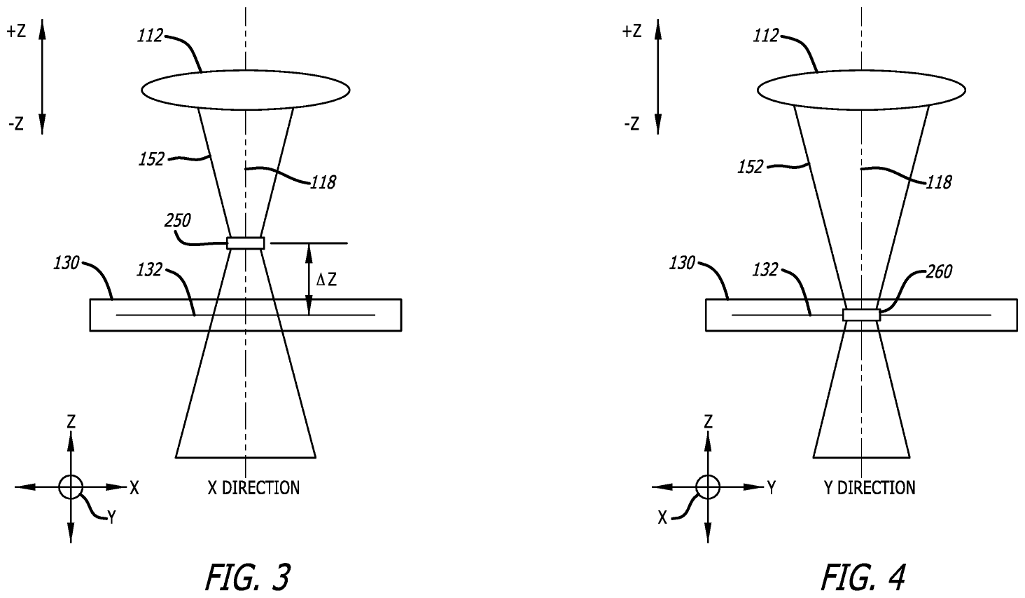

Regardless of the configuration of the first positioner 106, the beam analysis system 130 can be used to characterize any astigmatism of the chirped first-order beam 152 produced. Sec, e.g., the discussion below relating to FIGS. 3 and 4, which show cross-sectional views in the X- and Y-directions, respectively, of a chirped first-order beam 152 propagating through a scan lens 112 along a beam axis 118 and incident on the detector plane 132 of the beam analysis system 130. In the example shown in FIGS. 3 and 4, the first-order beam 152 has been chirped in the X-direction, but not in the Y-direction. It will be appreciated, however, that the first-order beam 152 may been chirped in the Y-direction but not in the X-direction or may be chirped in the X- and Y-directions in any manner.

As a result, the beam waist 250 of the chirped first-order beam 152 is shifted away from the detector plane 132 (e.g., above the detector plane 132, or below) along the Z-direction (e.g., by a distance AZ). The beam analysis system 130 can be operated to measure the spot size in the X- and Y-directions at the detector plane 132, and measurement data generated by the beam analysis system 130 can then be used to determine the distance, AZ. In one example embodiment, to measure AZ of the beam waist 250, the beam analysis system 130 can be mounted on a Z-axis stage (e.g., of the third positioner 110) so that the beam analysis system 130 (and the detector plane 132) can be moved in the +Z direction while spot size measurements are taken by the beam analysis system 130. In another example embodiment, the scan head 120 (shown in FIG. 1) is mounted on a Z-axis stage (e.g., of the third positioner 110) so that the beam waist can be moved in the +Z-direction, while spot size readings are taken by the beam analysis system 130. Data representative of the spot size is sent by the beam analysis system 130 to the controller 122 where AZ of the beam waist 250 is calculated by any suitable technique known in the art. By measuring the spot size along the X- and Y-directions as well as the distances AZ of the beam waists 250 and 260, the beam analysis system 130 can generate measurement data 160 representative of the beam astigmatism to the controller 122 (as shown in FIG. 2).

As described above, the AOD system 140 diffracts the incident beam 150 based on the frequency of the acoustic signal 148 propagating through the AOD crystal 144. When the acoustic signal 148 has a chirped waveform as described above, the AOD system 140 may diffract the incident beam 150 to produce a chirped first-order beam 152 incident on the detector plane 132 of the beam analysis system 130. The temporal relationship between the output of the control commands 164 sent to the AOD system 140 and the control commands 168 sent to the laser source 104 (hereinafter referred to as “timing offset”) can be important to various laser-processing applications where precise synchronization between a laser pulse (or pulses) and the acoustic signal in the AOD crystal 144 is required.

In embodiments in which the first positioner 106 is provided as a multi-axis AOD system as described above, the controller 122 may control the chirp of the RF signals for each AOD in the pair of AODs independently. In this instance, the spot size or shape in a first direction (e.g., the X-direction) may be different than the spot size or shape in a second direction (e.g., the Y-direction). Based on measurement data 160 characteristic of the spot size from the beam analysis system 130, the controller 122 can control the operation of the first AOD and the second AOD system 140 to change the degree of astigmatism, and thereby, the beam circularity and the spot size, at the workpiece 102 in one or both of the X- and Y-directions as required by the process being performed by the laser-processing apparatus 100.

i. Embodiments Concerning Changes to Beam Characteristics by System Operator or Automated Control

As described above, the incorporation of the beam analysis system 130 into the laser-processing apparatus 100 may enable a variety of methods for controlling beam characteristics. In one embodiment, if the operator of the laser-processing apparatus 100 wants to irradiate the workpiece 102 with a beam of laser energy having a specific beam diameter or spot size (e.g., to form a via in a printed circuit board substrate), the beam analysis system 130 is used to measure the beam diameter and transmit measurement data representative of the beam diameter to the controller 122. The system operator can review the measurement data 160 received by the controller 122 (e.g., on a software graphical-user-interface) and decide if changes should be made. If the system operator wants to change the spot size based on the measurement data 160, they can program the controller 122 to output updated control commands 164 for the RF source 146 to apply a chirped RF signal 170 to the ultrasonic transducer 142, creating a chirped acoustic signal 148 within the AOD crystal 144 to produce a first-order beam 152 having a specific spot size incident on the workpiece 102.

In another embodiment, when the laser-processing apparatus 100 is operating in an automated mode, (e.g., based on automated routines or sub-routines programmed by a system operator), the controller 122 may receive measurement data 160 from the beam analysis system 130 and, based on such programming, output updated control commands 164 for the RF source 146 to apply a chirped RF signal 170 to the ultrasonic transducer 142, thereby creating a chirped acoustic signal 148 within the AOD crystal 144 to produce a first-order beam 152 having a specific spot size incident on the workpiece 102.

ii. Embodiments Concerning Methods of Compensating for Changes in Beam Characteristics

In one embodiment, the beam analysis system 130 is used as part of the laser-processing apparatus 100 to compensate for changes in various beam characteristics, or to minimize the effect that a change in one beam characteristic (e.g., a “first” beam characteristic) has on another beam characteristic (e.g., a “second” beam characteristic). For example, when the AOD system 140 is operated to change a first beam characteristic of the incident beam (e.g., spot size) relative to the first-order beam, this change may cause a change in a second beam characteristic (e.g., spot positioning, beam astigmatism, etc.) of the first-order beam. To correct for, or reduce the effect of the change in the second beam characteristic, the beam analysis system 130 may measure the second beam characteristic and generate measurement data 160 representative of the second beam characteristic. The beam analysis system 130 may then transmit that measurement data 160 to the controller 122, where the controller 122 may compute and output updated control commands 164 based, at least in part, on the measurement data 160, to the AOD system 140 so the AOD system 140 can reduce the magnitude of the change in the second beam characteristic.

In one embodiment, to achieve a desired spot size at the workpiece, the AOD system 140 is operated to produce a chirped first-order beam 152 based on a first chirped acoustic signal 148. The center frequency of the first chirped acoustic signal 148 may result in a spot position error (the difference between the desired spot position and the actual spot position). The beam analysis system 130 may measure the spot position of the chirped first-order beam 152 and transmit measurement data 160 representative of the measured spot position to the controller 122. Upon receiving the measurement data 160, the controller 122 may compute the spot position error and, to correct the spot position error, may transmit updated control commands 164 to the AOD system 140 to create a second chirped acoustic signal 148 having the same chirp rate as the first acoustic signal but having a different center frequency, thereby reducing, or eliminating, the spot position error.

In another embodiment, the control commands 164 can be operated to correct a beam astigmatism of the first-order beam 152. As described above, a chirped acoustic signal has the effect of applying a single-axis focusing term to the first-order beam 152. This may result in beam astigmatism (defined as a beam having differing focal points in orthogonal axes). The beam analysis system 130 measures the beam astigmatism by measuring the difference in height AZ between the focal point (or beam waist) and the detector plane 132 in an X-direction and between the focal point (or beam waist) and the detector plane 132 in a Y-direction (as described above). When the AOD system 140 is provided as a multi-axis AOD system, the controller 122 may operate one AOD (e.g., a second AOD) to create a chirped acoustic signal that applies a single axis defocusing term to the beam to correct the astigmatism caused by chirping the first AOD.

iii. Embodiments Concerning Correction of Timing Errors Between the Laser Source and the AOD System

Referring to FIG. 2, in some laser-processing applications (e.g., to form one or more features on a workpiece 102), the incident beam 150 (e.g., a laser pulse or group of laser pulses) may be intended to transit the AOD system 140 coinciding with a particular chirped acoustic signal 148 (e.g., having a particular chirp rate to achieve a particular spot size, and/or, having a particular center frequency to achieve a particular spot position at the workpiece 102) in the AOD crystal 144. Because the diffraction angle θ imparted by the AOD system 140 corresponds to the center frequency of a chirped acoustic signal across the transverse dimension of the laser pulse within the AOD crystal 144, if the laser pulse does not transit the AOD crystal 144 overlapping the expected or desired chirped acoustic signal 148, the laser pulse will be delivered to a spot position on the workpiece 102 that is different that the desired spot position. A control loop can be used to adjust the timing offset between the control commands 168 sent to the laser source 104 and the control commands 164 sent to the RF source 146, to correct for timing errors to ensure timing fidelity and prevent such spot position errors.

In some embodiments, a timing error results in a laser pulse transiting the AOD crystal 144 coinciding with a second chirped signal (having a second chirp rate), instead of transiting the AOD crystal 144 coinciding with a first chirped signal (having a first chirp rate), with the first chirped signal and the second chirped signal being discrete, temporally separated chirped signals. In other embodiments, a timing error results in a laser pulse transiting the AOD crystal 144 coinciding with a different (than intended) frequency band of a relatively long (e.g., longer than the transit time of the pulse through the AOD crystal 144), continuously chirped signal (i.e., having a constant chirp rate), with each frequency band having a different center frequency. In yet other embodiments, a timing error results in a laser pulse transiting the AOD system 140 at a region where there is no acoustic waveform.

In one embodiment, a timing error results in a laser pulse transiting the AOD crystal 144 coinciding with a second chirped signal (having a second chirp rate), instead of transiting the AOD crystal 144 coinciding with a first chirped signal (having a first chirp rate), with the first chirped signal and the second chirped signal being temporally separated. In this embodiment, an exemplary method for correcting the spot position errors due to these timing errors first involves a measurement step operative to develop a correlation between a reference beam characteristic (e.g., spot position) and the timing offset. This correlation is used in a subsequent workpiece-processing step that applies the correlation, wherein the timing offset has a predetermined relationship to that reference beam characteristic (spot position), thereby enabling the laser-processing apparatus 100 to avoid, correct or reduce spot position errors. During the measurement step, the beam analysis system 130 measures the laser spot position, and generates measurement data 160 representative of the measured spot position for each laser pulse. When this measurement data 160 is sent to the controller 122, the controller 122 develops a correlation between the measured spot position and the timing offset (e.g., automatically, or as programmed by a system operator). For example, the controller 122 sends control commands 164 to the AOD system 140 so the RF source 146 creates a first chirped RF signal resulting in a first chirped acoustic signal (e.g., with a chirp rate of 5 MHz/μs and a center frequency of 30 MHZ) in the AOD crystal 144. The controller 122 also sends control commands 168 to the laser source 104 to emit a first laser pulse intended to overlap the first chirped acoustic signal, expecting the AOD system 140 to diffract the pulse to the beam analysis system 130 to a desired spot position. Generally, the control commands 164 and 168 are temporally offset relative to one another (e.g., by a timing offset T₀) to ensure that the chirped laser pulse is diffracted to the desired spot position. However, for example, the first laser pulse may miss the first chirped acoustic signal and instead overlap a second chirped acoustic signal temporally separated from the first chirped signal (e.g., having the same chirp rate of 5 MHz/μs, but having a center frequency of 26 MHz), resulting in a spot position error (e.g., of 1 μm). The beam analysis system 130 measures the spot position and transmits measurement data 160 representative of the measured spot position of that first laser pulse to the controller 122. The controller 122 then computes a spot position error (e.g., E₀) correlated to the timing offset T₀ for that first laser pulse. By repeating the spot position measurement while adjusting the timing offset (e.g., T₁, T₂, T₃, T₄, etc.) and calculating the resultant spot position errors (e.g., E₁, E₂, E₃, E₄, etc.), the controller 122 develops a correlation between timing offset and spot position error that characterizes the relationship between timing offset and spot position error. The controller 122 then applies a correction to the timing offset during a subsequent workpiece-processing step to reduce or eliminate the spot position error. During this workpiece-processing step, the controller 122 will send control commands 164 to the AOD 140 to generate a chirped acoustic signal 148 within the AOD crystal 144, and sends control commands 168 to the laser source 104 to emit a laser pulse to be diffracted to the workpiece 102 by the intended chirped signal. Because the timing offset was correlated with the measured beam characteristic (spot position) during the measurement step, the timing offset has a predetermined relationship with the reference characteristic (spot position). The controller 122 uses this predetermined relationship to improve the timing fidelity between the AOD control commands 164 and the control commands 168 to reduce or eliminate spot position errors.

In another embodiment, an exemplary method can correct for two errors (e.g., spot size errors and spot position errors, in one or more directions) that occur simultaneously due to timing errors. In the example workpiece-processing scenario described above, a change in fluence of the first-order beam 152 may be required between the ablation of the metal layer of a printed circuit board (using a non-chirped beam) and the ablation of the underlying laminate material (using a chirped beam). To achieve this, a non-chirped acoustic signal in the AOD crystal 144 that diffracts the incident beam 150 as a focused first-order beam 152 would be followed by a chirped acoustic signal that diffracts the incident beam 150 as a defocused first-order beam 152 (i.e., having a lower laser fluence) to the same process spot. If the laser pulse intended to ablate the metal layer (e.g., requiring a non-chirped acoustic signal) transits the AOD crystal 144 overlapping the chirped acoustic signal, two problems may be created. First, the laser pulse may be defocused by the chirped acoustic signal to the point where it does not have the required fluence to ablate the metal layer. Second, if the center frequency of the chirped acoustic signal across the laser pulse is not equal to the frequency of the non-chirped acoustic signal across the laser pulse, a spot position error would result. By applying a method similar to that described above involving a measurement step used to correlate a timing offset to the reference beam characteristics (e.g., spot size and spot position), followed by a workpiece-processing step that uses an updated timing offset based on the predetermined relationship the timing offset and the beam characteristics, the errors in the spot position and spot size are minimized, corrected or avoided.

In this example, during the measurement step, the beam analysis system 130 can measure the spot position and the spot size, and generate measurement data 160 representative of both measured characteristics for each laser pulse, and transmit the measurement data 160 to the controller 122. The controller 122 then develops a correlation between the measured spot position, the measured spot size, and the timing offset. For example, the controller 122 may send control commands 164 to the AOD system 140 so the RF source 146 creates a non-chirped acoustic signal (e.g., with a frequency of 30 MHZ) followed by a chirped acoustic signal (e.g., with a chirp rate of 5 MHz/μs and a center frequency of 32 MHZ) in the AOD crystal 144. The controller 122 may then send control commands 168 (e.g., with a timing offset T₀ relative to the control commands 164 sent to the AOD system 140) to the laser source 104 to emit a first laser pulse intended to overlap the non-chirped acoustic signal, expecting the AOD system 140 to diffract the pulse to the beam analysis system 130 to a desired spot position with a desired spot size. However, for example, the pulse may miss the non-chirped acoustic signal and instead overlap a portion of the chirped acoustic signal that has a center frequency of 32 MHZ, resulting a non-desired spot position and a non-desired spot size. The beam analysis system 130 measures the spot position and spot size and transmits measurement data 160 representative of the measured spot position and measured spot size of that laser pulse to the controller 122, allowing the controller 122 to compute a spot position error (e.g., ESP₀, the measured spot position relative to the expected spot position) and a spot size error (e.g., ESS₀, the measured spot size relative to the expected spot size), with both errors correlated to the timing offset T₀ for that laser pulse. By repeating the spot position and spot size measurements while adjusting the timing offset (e.g., T₁, T₂, T₃, T₄, etc.) and calculating the resultant spot position and spot size errors (e.g., ESP₁, ESS₁, ESP₂, ESS₂, ESP₃, ESS₃, etc.), the controller 122 develops a correlation between the timing offset Tₓ, the spot position error ESPₓ, and the spot size error ESSₓ that characterizes the relationship between timing offset, spot position error and spot size error. Because the timing offset between the laser pulse, the non-chirped acoustic signal, and the chirped acoustic signal was correlated with the measured beam characteristics (spot position and spot size) during the measurement step, the timing offset has predetermined relationships with both of the reference characteristics (spot position and spot size). The controller 122 uses these relationships to improve the timing fidelity between the AOD control commands 164 and the laser control commands 168 to reduce or eliminate spot position and spot size errors during the workpiece-processing step.

iii. Embodiments Concerning Control of System Operating Parameters

The methods described above with respect to other closed loop control of system performance using measurement data from the beam analysis system 130 may be applied more broadly to various system operating parameters (e.g., RF signal frequency, RF signal chirp rate, acoustic signal chirp rate, AOD temperature, laser pulse burst envelope, pulse repetition rate, pulse energy, or the like or any combination thereof) that can be controlled to compensate for changes in performance of various components of the laser-processing apparatus 100. As the laser-processing apparatus 100 ages, various optical elements (e.g., gain crystals, gain fibers, harmonic generation crystals, optical gratings, prisms, relay optics, diffractive elements, beam delivery optics, AODs, lenses, or the like or any combination thereof), will degrade and change the nominal spot size. What follows below is a discussion of an embodiment for using the beam analysis system 130 to compensate for the effects that such degradation has on the nominal spot size.

In one embodiment, for example, a system operating parameter could be the chirp rate, C, of the RF signal 170 applied to the ultrasonic transducer 142 by the RF source 146 (e.g., in response to control commands 164 from the controller 122). In this embodiment, as the scan lens 112 ages, accretion of debris during laser processing may result in increased absorption of the beam of laser energy, resulting in higher operating temperatures of the scan lens 112, and thermal lensing that changes the nominal spot size, possibly unknown to the controller 122 and system operator. Measurement of a beam characteristic with the beam analysis system 130 can be used to detect such errors and compensate for them. In this embodiment, an exemplary method to implement this includes measurement steps executed at various times throughout system operation, where a beam characteristic (e.g., spot size) is selected as a reference characteristic. If a particular measurement (e.g., by the beam analysis system 130) of the reference beam characteristic in response to a related system operating parameter departs from an expected value, (e.g., outside of expected tolerances or control limits), the controller 122 would use measurement data 160 from the beam analysis system 130 (e.g., as described above with respect to FIG. 2) to adjust the system operating parameter. In this embodiment, the reference beam characteristic to be measured is the spot size, S, corresponding to a system operating parameter, the chirp rate, C, of the RF signal 170 applied to the ultrasonic transducer 142 by the RF source 146. The RF signal chirp rate C₁ (e.g., 5 MHz/μs) used at system age, A₁, (e.g., when the spot size S₁ is 100 μm) is the reference value of the RF signal chirp rate. The beam analysis system 130 then generates measurement data for the spot size S as a function of system age, A (in time) and correlates S to the chirp rate, C, and the age A in the controller 122. As the system ages to, for example, age A₂, the spot size S₂ resulting from the reference value of the RF signal chirp rate, C₁, (e.g., 5 MHz/μs applied at age A₁) may change to S₂=120 μm. By comparing the spot size (S₂), with the reference value of the RF signal chirp rate (C₁) and the system age (A₂) using measurement data from the beam analysis system 130, the controller 122 uses the relationship between the system operating parameter and the reference characteristic to calculate an updated RF signal chirp rate, C₂ (e.g., 6 MHz/μs) that drives the AOD system 140 to achieve the desired spot size, S₁=100 μm. This method can be utilized to measure the chirped spot size and modify the chirp rate to ensure the spot size at the work surface is maintained over the life of the system. This ensures consistent laser-processing quality over the long term.

### B. Embodiments Concerning the Signal-to-Noise Ratio of the Beam Analysis System

In some embodiments, when using the beam analysis system 130 with high power beam delivery systems, the intensity of scatter generated by optical elements in the beam path may be of similar magnitude to that of the intensity of the process beam detected by the photodetector, especially if any attenuation of the first-order beam 152 is required to avoid damage to components of the beam analysis system 130 (e.g., when measuring 10-20 μm spot sizes that have very high laser fluence). This can result in difficulty in discerning the signal of the first-order beam 152 from the noise generated by the scatter, resulting in a low signal-to-noise ratio that degrades the fidelity of the beam analysis data. To accurately measure spot sizes in this range, it is important to improve the signal-to-noise ratio by reducing the amount of scatter reaching the photodetector. What follows below is a discussion of exemplary embodiments of the beam analysis system 130 that result in improved signal-to-noise ratio performance.

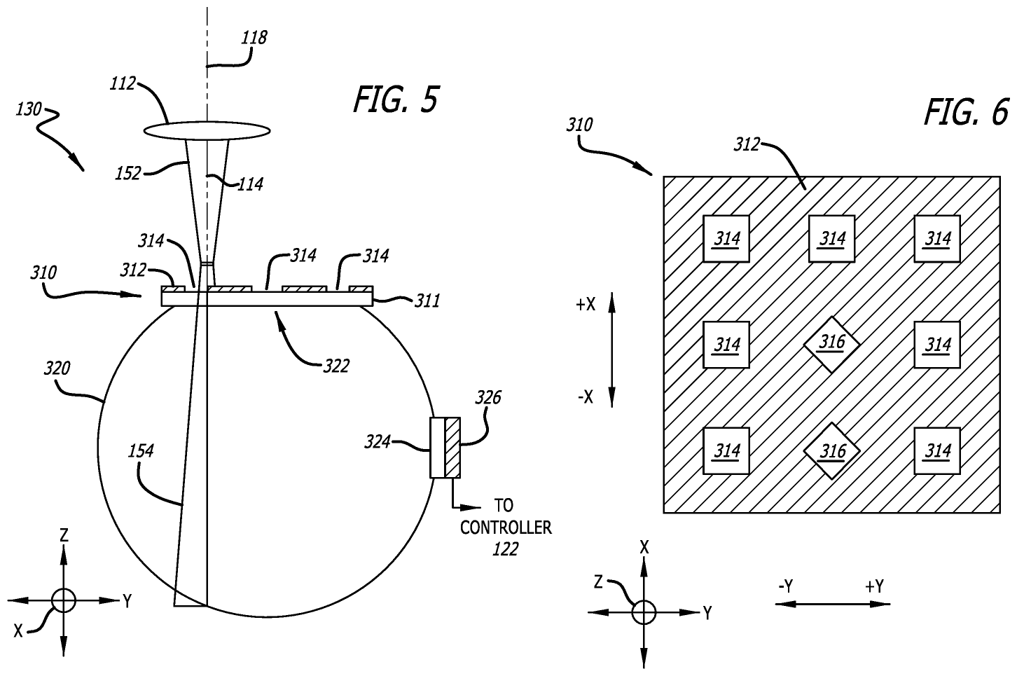

FIGS. 5 and 6 show various views of an exemplary embodiment of the beam analysis system 130 shown in FIG. 1. Referring to FIGS. 5 and 6, the beam analysis system 130 includes a token 310 mounted or positioned on a photodetector assembly. The token 310 includes a substrate 311 (e.g., formed from glass, quartz, or other optically transmissive material) with a material layer 312 (e.g., formed of metals, ceramics, optical coatings, etc.) configured to prevent at least a portion of the incident first-order beam 152 from reaching the photodetector assembly. In this embodiment, the material layer 312 is provided as highly reflective chrome (also referred to herein as “HR chrome”) configured to reflect the portion of the first-order beam 152 incident thereon. In another embodiment, the material layer 312 is provided as anti-reflective chrome (also referred to herein as “AR chrome”). A material layer 312 of AR chrome may have a lower laser-induced damage threshold (LIDT) than HR chrome, due to its absorption of the incident light, in contrast to the higher LIDT of the HR chrome by virtue of its reflection of the incident light. By virtue of the higher LIDT of the HR chrome, less attenuation of the first-order beam 152 is required, thereby improving the signal-to-noise ratio. One or more apertures (e.g., one or more apertures 314 and/or 316) can be formed in the material layer 312. The apertures 314 and 316 are configured to permit a portion of the first-order beam 152 (i.e., the transmitted portion 154) to pass through the substrate 311. The beam analysis system 130 may further include a cover (not shown) configured to be selectively positioned over the token 310 (e.g., when the beam analysis system 130 is not in use) to prevent the accretion of debris or other contaminants on the apertures 314 and 316 or the material layer 312. In this embodiment, the photodetector assembly includes an integrating sphere 320 and a photodetector 326. The photodetector assembly is configured to measure the optical power or energy of a portion of an incident first-order beam 152 having a beam axis 118 and propagating through a scan lens 112 along a beam path 114 as the beam axis is scanned over the token (e.g., along the X- or Y-axes).

As is known in the art, the integrating sphere 320 is an optical component that includes a hollow spherical (or at least substantially spherical) cavity, the interior surface of which is coated with a diffuse reflective coating. The integrating sphere 320 includes a collection port 322 and a detection port 324, and is arranged such that light propagating along the beam path 114 can enter into the cavity of the integrating sphere 320 through the collection port 322. Light incident on any point on the interior surface of the cavity is scattered and, ultimately, exits the integrating sphere 320 at the detection port 324 so as to be incident upon the photodetector 326. The token 310 is positioned on or adjacent to the collection port 322 of the integrating sphere 320. The power or energy of the transmitted portion 154 of the first-order beam 152 is measured by the photodetector 326 mounted in the detector port 324. The photodetector 326 is configured to absorb light entering the detector port 324 and transmit corresponding measurement data (e.g., as discussed above) to the controller 122.

FIG. 6 shows a plan view of an embodiment of the token 310 shown in FIG. 5. Referring to FIG. 6, the size, shape, orientation, or other configuration of the apertures 314 and 316 (each generically referred to as an “aperture”) may be provided in any manner as desired or beneficial. In this embodiment, a one or more square-shaped apertures (e.g., as identified at 314) having sides that are oriented to the X- and Y-axes (e.g., at 0 and 90 degrees, as measured from the X-axis) are provided. One or more diamond-shaped apertures (e.g., as identified at 316) having sides that are offset from the X- and Y-axes (e.g., at 45 and 135 degrees, as measured from the X-axis) are also formed in the material layer 312. The minimum distance between the edges of adjacent apertures (i.e., the “pitch” of the aperture array) is selected to minimize the transmission of scatter generated upstream in the optical train (e.g., at turning mirrors, lenses, and other optics) through adjacent apertures (i.e., the apertures where the first-order beam 152 is not directed to) into the integrating sphere 320 and reaching the photodetector 326. In addition, the pitch of the aperture array may be selected to avoid or minimize scatter from light reflected by the HR chrome of the material layer 312 toward other system components and being reflected by these system components and entering adjacent apertures. For example, in one embodiment, the pitch of the aperture array is chosen so that adjacent apertures are located far enough away from each other relative to their size (e.g., an aperture size of 250 μm with the space between apertures between about 1-2 mm) that the material layer 312 (e.g., made of HR chrome) covers more than 95% of the area of the token 310. Configured as such, the amount of scattered light incident upon the photodetector 326 is minimized or otherwise reduced. Another advantage of using the integrating sphere 320 is a reduction in the effect of aperture position on the photodetector measurement. If a photodetector is placed directly underneath the token 310, the amount of light from the first-order beam 152 reaching that photodetector may be different for apertures located at different positions on the token 310 (e.g., due to the first-order beam 152 being incident on the edge of the aperture at an angle relative to the plane of the token). The use of the integrating sphere 320 can reduce this positional sensitivity.

Referring to FIG. 5, during operation, to measure the characteristics of the first-order beam 152, the beam axis 118 is scanned across one or more edges of at least one aperture, while the optical power of the transmitted portion 154 of the first-order beam 152 is sensed by the photodetector 326. The edges of the apertures act similar to knife-edges used in a variety of beam profilers (e.g., scanning slit profilometers, or the like). In one example, beam characterization tool 130 may be used to measure the one or more characteristics of the first-order beam 152 and generate corresponding measurement data representative of the beam power reaching the photodetector 326, which may be transmitted to and processed by controller 122 (e.g., for any purpose as discussed above).

### IV. EMBODIMENTS CONCERNING BEAM STABILITY

In some cases, during operation of the laser-processing apparatus 100, when the galvanometer mirrors are driven at or near their respective performance limits, a parasitic force relative to the applied torque (e.g., by the galvanometer motors) may be caused by minor imbalances of the galvanometer mirror or shaft. The combination of these effects can excite cross-axis angular motion (e.g., motion orthogonal to the primary axis of rotation) of the mirror (also referred to herein as “cross-axis wobble”), causing errors in the angular position of the galvanometer mirror. This cross-axis wobble is typically not sensed by the galvanometer positioning system, and the errors in angular position of the galvanometer mirror can produce laser spot position errors at the surface of the workpiece 102 (e.g., after focusing the diffracted first-order beam through a scan lens). If the degree of cross-axis wobble can be measured, adjustment of the operation of the AOD system located optically upstream from the galvanometers can pre-compensate for the cross-axis wobble, thereby reducing or avoiding positioning errors. What follows below is a discussion of embodiments which enable detection and pre-compensation of cross-axis wobble.

### A. Measurement of Cross-Axis Wobble Using Beam Analysis System

In a laser-processing apparatus 100 that includes a first positioner 106 (e.g. an AOD system), and a second positioner 108 (e.g., one or more galvanometers), the beam axis 118 is positioned so that half of the spot (or, about half of the spot) is transmitted to the photodetector 326 (e.g., as shown in FIG. 5). Then, one of the galvanometers is driven not near its performance limit to scan the beam axis 118 in a direction parallel to the knife edge (e.g., the edge of one of the apertures 314 or 316). The measurement data from this scan sent to the controller 122, and the controller 122 stores this data (e.g., as a baseline measurement) to be compared to operation of the galvanometer at or near its performance limit.

If, as a result of operating the galvanometer at or near its performance limits, the galvanometer exhibits no cross-axis wobble, the beam analysis system 130 measurement will not change (e.g., when compared to the baseline measurement described above). If the galvanometer exhibits cross-axis wobble, the beam analysis system 130 measurement will change as compared to the baseline measurement. The measurement data is processed by the controller 122 into an error correction signal which is fed to the AOD system 140 to correct for the cross-axis wobble. The controller 122 may process the measurement data by filtering out various frequencies, compensating for sensing delays (e.g., due to sensor interface electronics), compensating for processing delays (e.g., due to data transmission, scaling, filtering, and AOD command data transmission) and AOD delays (e.g., propagation delays in the AOD drivers and AOD crystals). The controller 122 can geometrically map the measurement data to translate the wobble angle to worksurface displacement due to the geometry of the galvanometer mirrors and the scan lens. In another example, measurement of cross-axis wobble by the beam analysis system 130 can be used to sense an increase in the magnitude of cross-axis wobble that can indicate damage to one or more parts of the galvanometer system.

Constructed as described above, the beam analysis system 130 may also be used to measure the effects of disturbances to the laser-processing apparatus 100 that either affect operating parameters (e.g., spot size, spot position, or the like or any combination thereof), or prevent the beam analysis system 130 itself from providing accurate measurements. By positioning the beam axis 118 of the first-order beam 152 directly on the edge of one or more apertures 314 and observing the fluctuation of the optical power measured by the photodetector 326, the beam analysis system 130 can detect and quantify such a disturbance. For example, in one embodiment, measurement data taken by the beam analysis system 130 while a debris exhaust system is engaged may exhibit unacceptable signal-to-noise ratios. If measurements are taken by the beam analysis system 130 when the debris exhaust is engaged are compared to measurements taken when the debris exhaust is disengaged, the cause of the instability may be determined.

### B. Pre-compensation Using A Cross-Axis Wobble Correction System

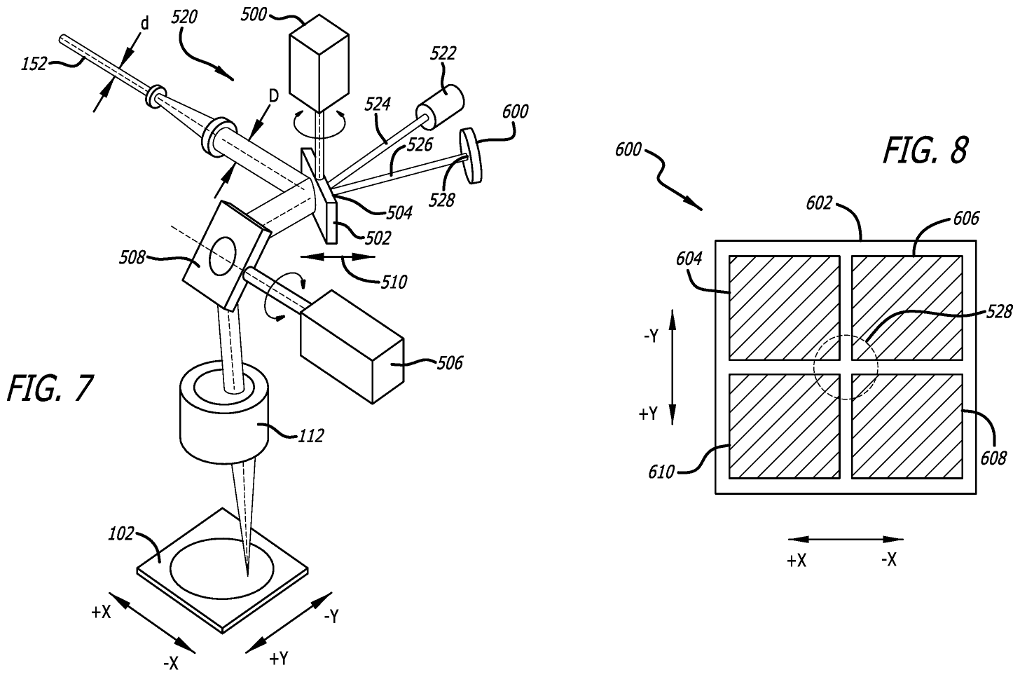

FIG. 7 shows a view of an embodiment of an apparatus (e.g., the cross-axis wobble correction system 520) operative to measure cross-axis wobble of a galvanometer mirror during operation of the laser-processing apparatus 100. A first-order beam 152 is incident on a first galvanometer mirror (e.g., an X-axis galvanometer mirror 502, driven by a galvanometer motor 500) and a second galvanometer mirror (e.g., a Y-axis galvanometer mirror 508, driven by a galvanometer motor 506) that directs the first-order beam 152 through a scan lens 112 to the workpiece 102. The wobble correction system 520 includes a reference laser source 522 operative to direct an incident reference laser beam 524 to a reflective surface 504 formed on the back side of the X-axis galvanometer mirror 502. The incident reference laser beam 524 is reflected from the surface 504 as a reflected beam 526 incident at a reference spot 528 on an auxiliary sensor 600. In another embodiment, an LED light source (not shown) may be used to emit an incident reference beam to the reflective surface 504.

FIG. 8 shows a view of an embodiment of the auxiliary sensor 600. In this embodiment, the auxiliary sensor 600 is provided as a quad-cell segmented photodiode with four segments 604, 606, 608 and 610 formed on a substrate 602. When the reference spot 528 is incident on the photodiode, each segment that is illuminated produces a photocurrent proportional to the optical power incident on that segment. The difference between the segment photocurrents indicates the position of the reference spot 528. As such, the auxiliary sensor 600 is configured to sense the position of the reference spot 528 and transmit measurement data representative of the position of the reference spot 528 to the controller 122. The controller 122 then uses this measurement data to compute correction or compensation factors and send control commands to the first positioner 106 (i.e., the X and Y AODs) so that they can correct or compensate for the cross-axis wobble 510, thereby ensuring that the cross-axis wobble 510 does not result in positioning errors of the process spot at the workpiece 102.

In this embodiment, during operation of the cross-axis wobble correction system 520, as the X-axis galvanometer mirror scans the first-order beam 152 in the ±X direction, the reference spot 528 moves in the ±X-direction on the auxiliary sensor 600. If, for example, cross-axis wobble 510 (e.g., in the Y-direction) occurs, the reference spot 528 may move in the ±Y-direction in addition to the ±X-direction, resulting in changes in the amount of light absorbed by the upper segments 604 and 606, relative to the light absorbed by the lower segments 608 and 610. Measurement data representative of this differential absorption of the reference spot 528 is sent from the auxiliary sensor 600 to the controller 122. The controller 122 then computes a compensation factor and outputs control commands (e.g., to the Y-axis AOD of the first positioner 106) to compensate for (and thereby correct) the Y-direction wobble, thereby preventing positioning errors of the process spot at the workpiece 102.

In another embodiment, the auxiliary sensor 600 is provided as a dual-cell segmented photodiode (not shown) having two segments arranged (e.g., in the Y-direction) on opposing sides of a gap (e.g., oriented in the in the X-direction). This dual-cell arrangement may avoid errors caused by non-linearity of the photodiode signal (e.g., from the quad-cell auxiliary sensor 600 as the reference spot 528 crosses the gap oriented in the Y-direction between the segments 606, 608 and segments 604, 610). In another embodiment, the auxiliary sensor 600 is provided as a continuous position-sensing photodiode (PSD). In other embodiments, the auxiliary sensor 600 may be provided as a capacitive displacement sensor, an eddy-current sensor, or an inductive sensor.

In another embodiment, the beam analysis system 130 (as described above with respect to FIGS. 5 and 6) is used as the auxiliary sensor 600. For example, the reflected beam 526 may be directed to the token 310 and the axis of the reflected beam 526 is scanned along the X-direction along the edge of one or more of the apertures 314. If cross-axis wobble 510 (e.g., in the Y-direction, as shown in FIG. 7) occurs, the axis of the reflected beam 526 may move back and forth across the edge of the aperture 314, resulting in changes in the amount of laser energy entering the integrating sphere 320. Measurement data representative of variations in the amount of laser energy that is measured by the photodetector 326 is sent to the controller 122, whereupon the controller 122 computes a correction or compensation factor and outputs control commands (e.g., to the Y-axis AOD of the first positioner 106) to correct or pre-compensate for (and thereby correct) the Y-direction wobble.

In another embodiment, the beam analysis system 130 may be used to develop pre-compensation of the cross-axis wobble by generating a wobble frequency response, defined as the gain and phase between on-axis position (due to galvo shaft rotation) and cross axis wobble motion (perpendicular to the on-axis motion), based on measurements taken by the beam analysis system 130. A dynamic model of the wobble frequency response can be derived from this measurement data, and this model can be used to predict and pre-compensate for wobble (using the modeled wobble data) in real time during processing of the workpiece 102.

While the embodiments described above relate to a cross-axis wobble correction system 520 used to correct for cross-axis wobble 510 of the X-axis galvanometer mirror 502, a similar or identical wobble correction system (not shown) may be used to measure and correct for cross-axis wobble (e.g., along the X-direction) of the Y-axis galvanometer mirror 508. In other embodiments, compensation of cross-axis wobble may also be possible using independent beam steering devices such as fast steering mirrors (FSMs).

### V. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

1. A laser-processing apparatus, comprising:
a laser source operative to generate a beam of laser energy, wherein the beam of laser energy is propagatable along a beam path;
an acousto-optic deflector (AOD) arranged within the beam path, wherein the AOD is operative to diffract the beam of laser energy;
a controller coupled to the AOD; and
a beam analysis system operative to measure one or more characteristics of the beam of laser energy, generate measurement data representative of one or more of the measured beam characteristics, and transmit the measurement data to the controller,
wherein the controller is operative to control an operation of the AOD based, at least in part, on the measurement data.

2. The laser-processing apparatus of claim 1, wherein the characteristic of the beam of laser energy is at least one of pulse repetition rate, beam diameter, spot size, circularity, beam astigmatism, focus height, beam waist, or beam axis position.

3. The laser-processing apparatus of claim 1, wherein the AOD includes a pair of AODs operative to diffract the beam path in a first direction and a second direction, respectively.

4. The laser-processing apparatus of claim 1, wherein the beam analysis system includes at least one of a camera-based beam profiler, a Rayleigh-scattering beam profiler, and a rotating slit beam profiler.

5. (canceled)

6. (canceled)

7. The laser-processing apparatus of claim 1, wherein the controller is operative to control an operation of the AOD to change at least one of the beam diameter, the spot size, the circularity, the astigmatism, the focus height, the beam waist, or the beam axis position of the beam of laser energy.

8. A method of controlling laser beam characteristics, comprising:
generating a beam of laser energy;
directing, using at least one AOD, the beam of laser energy along a beam path to a beam analysis system;
measuring, using the beam analysis system, one or more characteristics of the beam of laser energy;
generating measurement data representative of one or more of the measured beam characteristics;
transmitting the measurement data from the beam analysis system to a controller; and
outputting control commands from the controller to the at least one AOD based, at least in part, on the measurement data.

9. The method of claim 8, wherein one of the one or more beam characteristics is at least one of pulse repetition rate, beam diameter, spot size, circularity, astigmatism, focus height, beam waist, or beam axis position.

10. The method of claim 8, wherein the at least one AOD, based on the measurement data is operative to change at least one of a beam diameter, a spot size, a spot position, a circularity, an astigmatism, a focus height, a beam waist, and a beam axis position of the beam of laser energy.

11. (canceled)

12. (canceled)

13. (canceled)

14. (canceled)

15. (canceled)

16. (canceled)

17. (canceled)

18. (canceled)

19. (canceled)

20. (canceled)

21. The method of claim 8,
wherein the at least one AOD is operative to change a first characteristic of the beam of laser energy, thereby changing a second characteristic of the beam of laser energy, the method further comprising:
measuring, using the beam analysis system, the second beam characteristic;
generating measurement data representative of the measured second beam characteristic;
transmitting the measurement data from the beam analysis system to a controller; and
outputting control commands from the controller to the at least one AOD based, at least in part, on the measurement data, wherein the at least one AOD is operative reduce the magnitude of the change in the second beam characteristic.

22. The method of claim 8, wherein the at least one AOD includes a pair of AODs.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. The laser-processing apparatus of claim 1, wherein:
the AOD is operative to change a first characteristic of the beam of laser energy, thereby changing a second characteristic of the beam of laser energy; and
the beam analysis system is operative to:
measure the second beam characteristic;
generate measurement data representative of the measured second beam characteristic;
transmit the measurement data from the beam analysis system to the controller; and
output control commands from the controller to the AOD based, at least in part, on the measurement data, wherein the AOD is operative reduce the magnitude of the change in the second beam characteristic.

42. The laser-processing apparatus of claim 41, wherein the AOD includes a pair of AODs.
